(19) United States
(12) Patent Application Publication
(10) Pub. No.: US 2002/0091509 A1
(43) Pub. Date: Jul. 11, 2002

(54) Method and system for translating text

(76) Inventors: Yacov Zoarez, Jaffa (IL); Roy Zoarez, Jaffa (IL)

Correspondence Address: Rosenman & Colin LLP, 575 Madison Avenue, New York, NY, 10022-2585, US

(21) Appl. No.: 09/752,931

(22) Filed: Jan. 2, 2001

(51) Int. Cl. G06F 17/28

(52) U.S. Cl. 704/6

(57) ABSTRACT

A method for automatic translating text sentences from source language to target language using dictionaries of vocabulary and thesaurus of plural languages, grammar function of each word translation index, vocabulary of verbs paradigrm, vocabulary of preposition, adverb and adjectives inflections.

The basic concept of translation according to the present invention is to analyze and parse the text object step by step in order to identify the sentence context and Its grammar formats. The analysis is preformed separately for each part of the sentence part, Each stage of analysis and translation is based on the former analysis. The translation and phrasing of the sentence to the target language is base upon the sentence analysis.

The said method of translation can be further used for online automatic translation of web page for Internet users, The present invention provides the user with designated converter for translating text object received from the Internet communication from the original language to any designated target language.

### FIELD OF THE INVENTION

The invention relates to a method of translating text sentence from one language to a second language, more particularly, the present invention relates to online translation of web pages over the Internet

### BACKGROUND OF THE INVENTION

For purposes of this disclosure, by the term “network” is meant include at least t computers connected through a physical communication line which can be hardwired. or virtual, such as satellite, cellular or other wirele5s communications. Computer can mean a personal computer, server or other similar-type device capable of receiving, transmitting, andior manipulating data for such purposes as, but not limited to, display on a display unit connected thereto.

The World Wide Web has become a popular medium for information exchange, Literally millions of new Web pages have been developed in the past several years as more and more individuals, businesses and organizations have discovered the power of web netark Many of these Web pages are written only in English. Non-English speaking users often have difficulty reading Web pages written in English, and thus may have difficulties to take advantage of information available on the vveb

Current automatic translation software which translates text Web pages from a source language such as English to a foreign native language, typically utilize databases that contain information about various languages and a translation module that refers to this database when performing automatic translation. Utilizing such automatic translation software with Web browser's proxy function enables to translate documents transmitted to the Web browser and display the document translation on the user's screen Exemplary automatic translation sofware of this type is “King of Internet Translation Ver 1.x, sold by IBM Japan, Ltd.

Unfortunately, it can be difficult to automatically translate text in one language to text in another language so that the meaning of the original text is accurately reflscted in the translation. Further more it is difficult to phrase correctly the translated text and comply with the grammar rules of the translation language This may often be a result of the ambiguity inherent in various languages. For example, ambiguity may arise from the use at words that have more then one meaning and that frequently appear in the text to be translated. When translating such word, one must select the appropriate meanings in relation to the sentence context and meaning.

Another source of ambiguity may arise from variations in grammar rule and formats betwen different languages, English sentences, for example. have specific structural sentence words sequence, such as “subject-verbobject.”When pronouns such as “that”, “which”, and “why” are omitted understanding English sentence patterns and grammar may be difficult. Words in sentence have different grammar function, and thus must be treated differently. Each word should be analyzed separately and in conjunction with the other wrcis of the sentence in order to attain proper translation. It is thus a prime object of the invention to avoid at least some of the limitations of the prior art and to provide a method and system for online automatic translation from original language text to any other language.

### SUMMARY OF THE INVENTION

A method for translating text sentences from source language to target language using databases including vocabulary and thesaurus of source and target languages, grammar function of each word, translation index, vocabulary of verbs paradigm, vocabulary of preposition, adverb and adjectives inflections, said method comprising the steps of: breaking sentence to text fragments according to punctuation marks; identifying grammar form of text fragments according to verb inflection, punctuation marks and grammar key words; identifying dominant tense form of sentence according to verb inflection and identified grammar form of text fragments; identifying subject of text fragment by locating the word appearing next to the first preposition wherein the exact location of the word (before or after the preposition) is specified according to sentence grammar rules of the source language; locating all verbs in text fragment and translate each verb to source grammar form in target language using translation index, inflecting each translated verb using vocabulary paradigm according to dominant tense form and according to identified subject; locate all nouns in text fragment and translate each noun to source grammar form in target language using translation index, analyzing each noun word grammar form and inflection such as single/plural or male/female; locating all adjectives, prepositions and article words relating to each noun; translating located adjectives, prepositions and article words using translation Index acccording to respective vocabulary and translation index; inflecting translated adjectives, prepositions and article words according to nouns grammar form using respective vocabulary paradigm; and re-arranging translated words order in each text fragment using grammar rule of target language according to grammar function of each word;

### BRIEF DESCRIPTION OF THE DRAWINGS

These and frther features and advantages of the invention will become more clearly understood in thc light of the ensuing desciption of a preferred embodiment thereof, given by way of example only. with reference to the accompanying drawings, wherein.

FIG. 1 is a general diagram block of the automatic translation system according to the present invention;

FIG. 2 is a flow-chart illustrating the method of convexting web-page text form source language to target language according to the present invention;

FIG. 3 is a flow-chart of the sentence translation modulc according to the present invention

FIG. 4 is a flow-chat of word translation module according to the present invention;

FIG. 5 is a flow-chart illustrating the method of detennining sentence Srammar form according to the present invention;

FIG. 6 is a flow-chart Wlustrating the method of deternnuuig domnant tense of text sentence according to the present invention,

FIG. 7 is a flow-chart ilustrating the method of determining sentence subject according to the present invention;

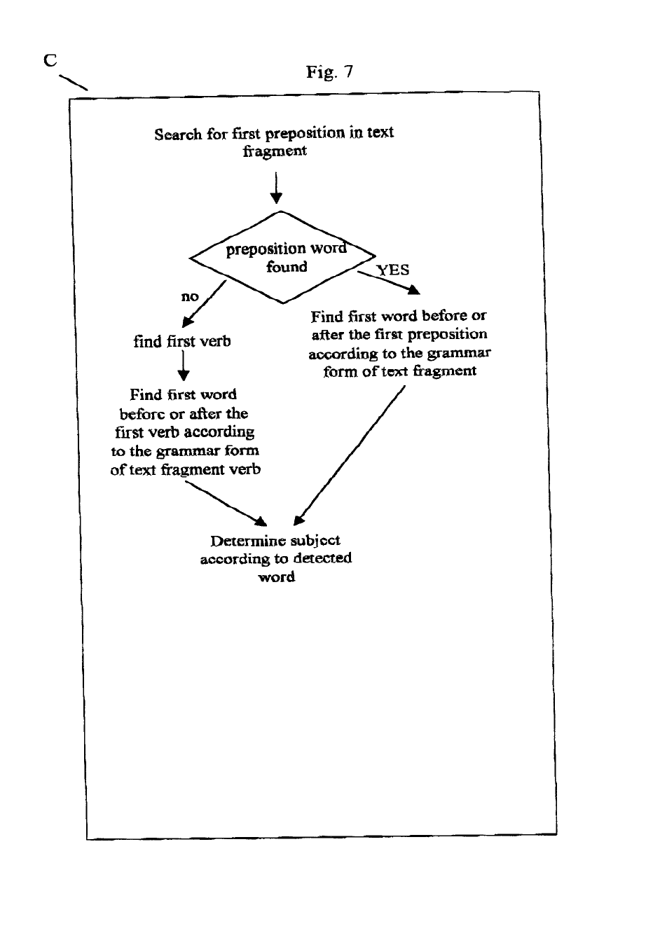

FIG. 8 is a flow-chart illustrating the method of rearrangin word order in sentence according to the present invention;

### DETAILED DESCRIPTION OF THE PREFERRED EMBODIMENTS

The embodiments of the invention described herein are implemented as logical operations in a computing system The logical operations of the present invention are presented (1) as a sequence of computer implemented steps running on the computing system and (2) as interconnected machine modules within the computing system The implementation is a mattter of choice dependent on the performance requirements of the computing network system implementing the invention. Accordingly, the logical operations making up the embodiments of the invention described herein are referred to variously as operations, steps, or modules.

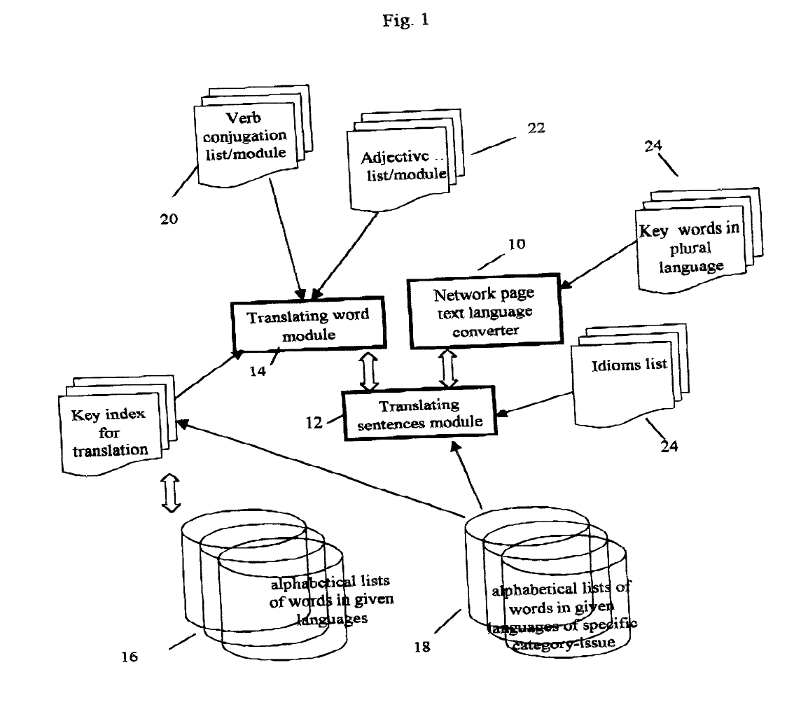

FIG. 1 block diagram illustrates the structure of wet-page translation system. As seen in FIG. 1 onversion module 10 is associated with user browser and controls the operation of the sentence translation module 12 (“Sentence module”)) The convector module function is to intercepts all incoming data from network for instance, e-mail, web page etc., detect text data and translate thereof to desired language. (detailed description of the converter module will be described do bellow). The detected text data is analyzed by the sentence module 12 to identify the sentence context and dominant grammar features. The analysis results are used by the word-translating module 14 for selecting and phrasing the proper translation for each word or idiom. The translating modules 12 and 14 are using different databases containing vocabularies of words for different functions.

Databases 16 and 1B include vocabulary of words of at least two languages whverein key index 26 correlates between corresponding words of any pair of different language. These databases include information of each word grammar function in the sentence such as noun, verbs, adjectives etc, Thus translating modules Use these databases not only for translation, but also for detecting the grammar function of the words.

Database or alternatively designated respective modules 20,22,24 and 26 enable to phrase the words in different language according to respective language grammar rules. Database 26 contains vocabulary of idioms for each translated language wherein each idiom contains at least two words.

The translation system according to the present invention can be implemented as software application at the user end, or alternatively as application service at a remote network server such as Internet service provider (ISP).

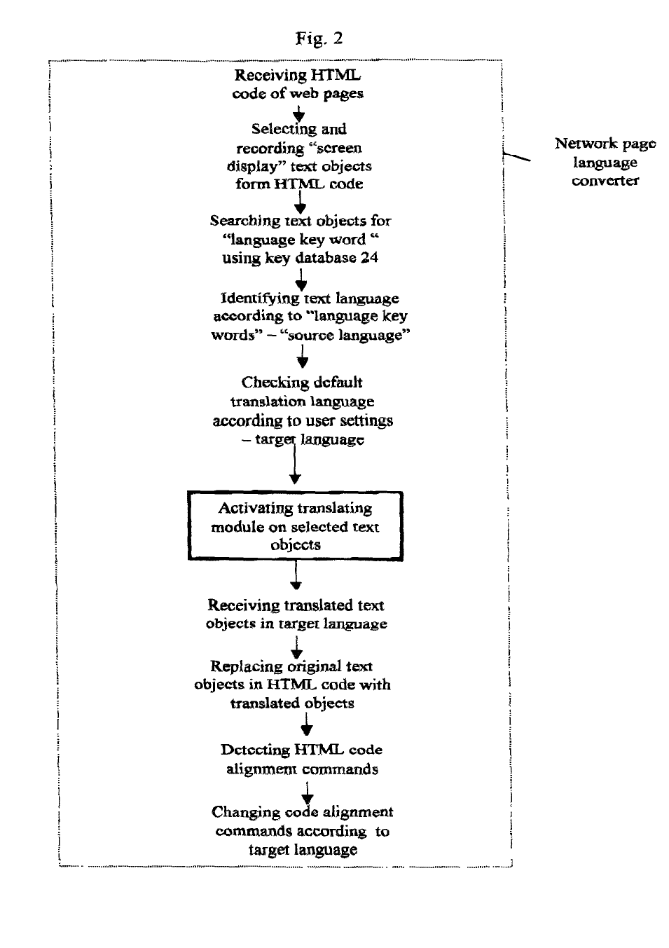

FIG. 2 illustrates the flow chart of the web page converter. The converter receives any kind of network data such as HTML web-page code, and parses the data to detect text objects designated for screen display. Each text object Is examined to determine it's dominant language (“Source language”). The source language is identified according to common words of each language sucn as “The” or “for” in the English language by using the common word database 24, The converter activates the sentence translation module to translate the text object from the source language to the designated target language as was predefined by the user. The converter module creates new web page based on the original HTML code wherein original text objects are replaced by translated text object as phrased by the Sentence module. Furthermore, alignment and display commands of the HTML code are changed according to target language paragraph format rules.

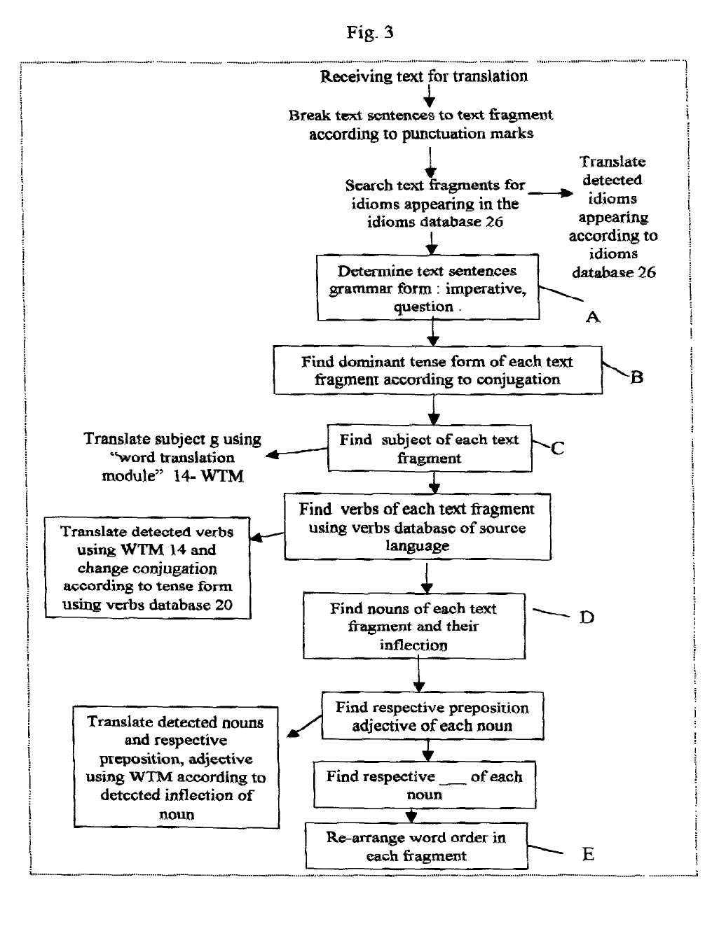

FIG. 3 illustrates the workflow of the Sentence module. The basic concept of this module is to analyze and parse the text object step by step in order to identify the sentence context and its grammar formats. The order of performing the analysis steps is essential for achieving best translation and phrasing results. The analysis is preformed separately for each sentence part (“Text fragments”), wherein each sentence part is identified by punctuation marks such as “.”,”” etc. Although the translation process is more efficient according to the preferred stages order as suggested according to the present invention, different order of the stages can be used. Moreover, in case of grammar rules of different languages, the order of stages can be changed accordingly.

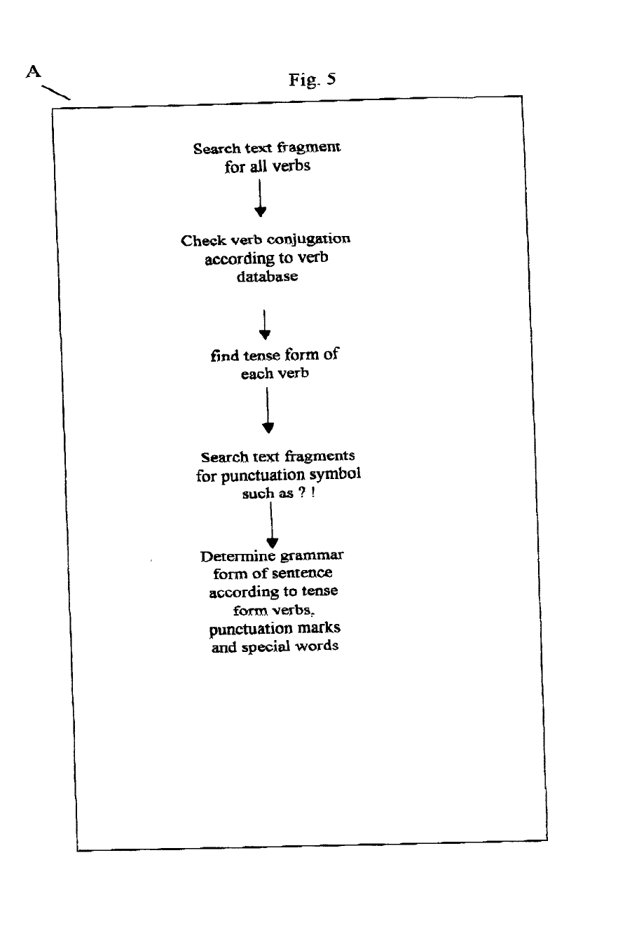

The first essential stage is determining the dominant sentence grammar format (See step A in FIG. 3) such as imperative, question. passive voice etc. The process of determining said format is illustrated in FIG. 5. The basic parameters used for such analysis are punctuation marks (e.g “?” or “!”), tense form of verbs and special grammar Aerds such as “be”“was” etc., although the rules for such analysis may be different for each source language the concepts remains the same.

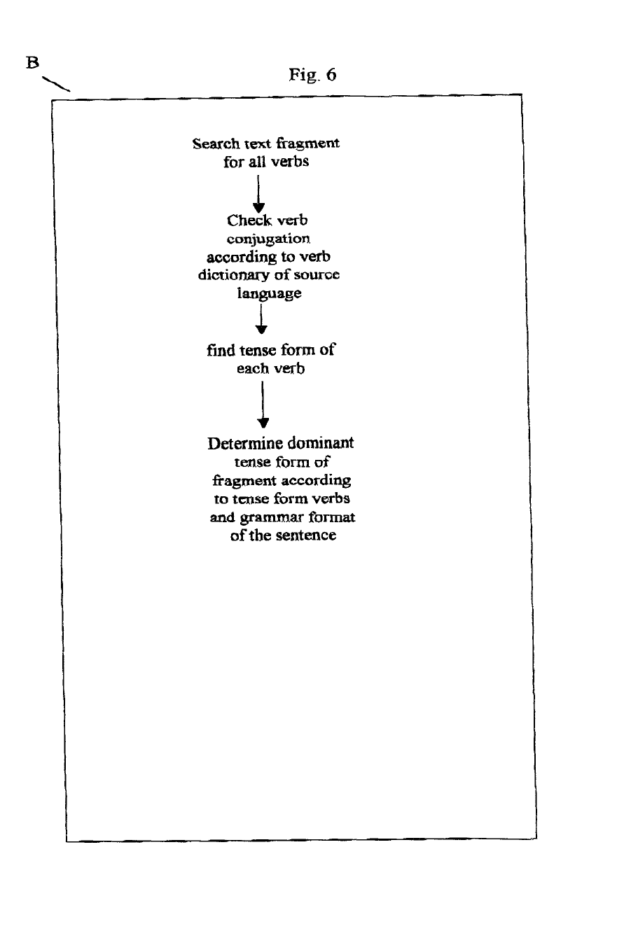

The next stage is to identify the dominant tense form of each text fragment (see step b in FIG. 3). Step B process is illustrated in FIG. 6, the dominant tense form is determined by verb conjugation of all detected verbs and the grammar format as was identified in the first step.

The third essential stage of the process is determining the sentence context, first by identifying the sentence subject (see step C in FIG. 3). The process of stop C is illustrated in Fig, 7. The basic idea is to find the dominant word which is the subject of the text fragment. Most frequently the subjected is located after/before the first preposition word in sentence or alternatively after the first verb. The location of the subject is depended on the grammar form of the text fragment, for example if its passive the subject appears after the first verb according to English grammar rules. The rules must be changed according to source language grammar rules. The sentence context can be further determined by key vwords which are commonly used in specific areas (e.g. computers, medicine etc.)

According to further embodiment of the present invention it is suggested to identify sentence context according to key verds given by the author of the web page which are written within the HTML code.

According to furthermore embodiment of the present invention it is suggested to use an idioms database 26 for identifying group of words which have special meanings. Proper translation of said idiom might be essential for identifying the sentence context.

The fourth essential stage of the process is analyzing each of the nouns type and inflection, see step D in FIG. 3. Basically, this process identifies the affixes added (e.g. “s”) or alterations of the noun, indicating of plurall single, male/female forms. This analysis is essential for the phrasing and inflecting of words relating to the noun such as prepositions, adjectives etc

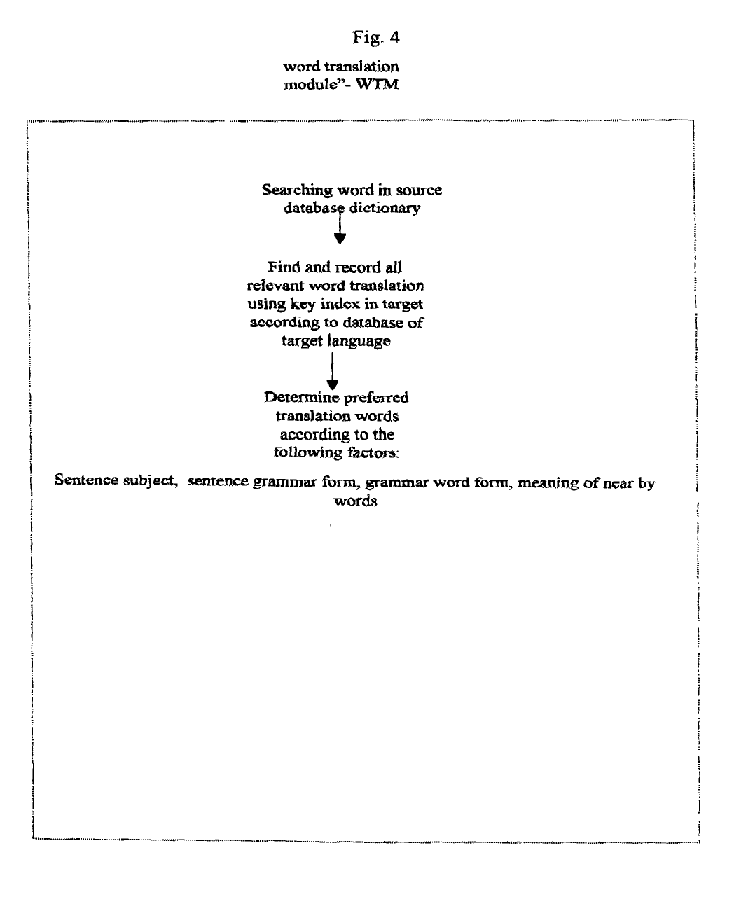

Once completing the above analysis, the Sentence module translates each of the text fragment words by activating the word translation module (“Word module”). FIG. 4 illustrates the word translation process Each word is translated by using the vocabulary database 12, 14 and respective translation index 28, Most frequently, words of the source language has more then one meaning and different synonyms of the words of the target language can be chosen for translation The preferred translation according to the present invention is determined according to results of the sentence analysis, including sentence context, sentenc subiect, sentence grammar form, word grammar form and meaning of near by words,

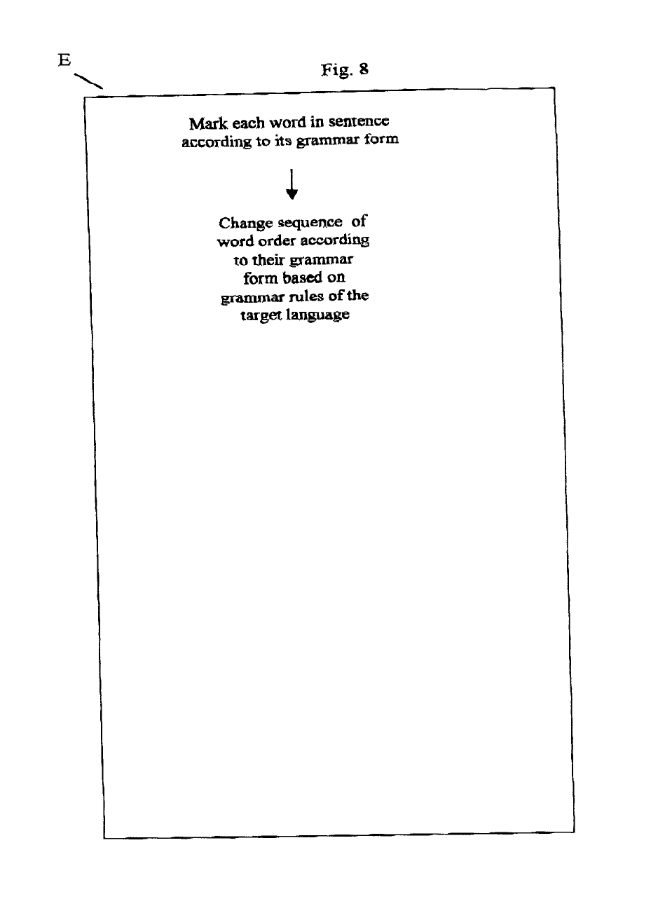

Finally, after all words of the text fragment are translated, the word order must be re-arranged to fit the grammar rules of the target language. This process is illustrated in FIG. 8. The word order in the sentence is determined by the grammar function of each word in each language there are different rules for word order, hence the location of each word in the sentence must be changed accordingly.

According to further embodiment of the present invention it is suggested to record short sentences original text and respective translation which are frequently translated form one language to another. Maintaining records of such sentences in a designated database can improve the performance of the translating process.

According to another embodiment of the present invention it is suggested to record translation of complete web pages. It is known that some web pages are visited more frequently than other pages. Such pages are usually cached at the end user or alternatively at proxy Intemet server (Gnga ISP servers). Therefore it is suggested to store along with the cached web page their respective translation. As a result, time latency of translating web pages is reduced

While the above description contains many apecifities, these should not be construed as limitations an the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents

WHAT IS CLAIMED IS:

1. a method for translating text sentences from source language to target language using database including vocabulary and thesaurus of source and target languages, granmma fiuntion of each word, translation index vocabulary of verbs paradigm, vocabulary of preposition, adverb and adjetives inflections, gaid method comprising the steps of:
(i) Breaking sentence to text fragments according to punctuation marks;
(ii) Identifying grammar form of text fragments according to verb inflection, punctuation marks and grammar key words;
(iii) Identifying dominant tense form of sentence according to verb inflection and identified grammar form of text fragments,
(iv) Identifying subject of text fragment by locating the word appearing next to the first preposition wherein the exact location of the word (before or after the preposition) is specified according to sentence grammar rules of the source language;
(v) Locating all verbs in text fragment and translate each verb to source grammar form in target language using translation index;
(vi) Inflecting each translated verb using vocabulary paradigm according to dominant tense form and according to identified subject;
(vii) Locate all nouns in text fragment and translate each noun to source grammar form in target language using translation index;
(viii) Analyzing each noun word grammar form and inflection such as single/plural or malet/female;
(ix) Locating all adjectives, prepositions and article words relating to each noun;
(x) Translating located adjectives, prepositions and article words using translation index according to respective vocabulary and translation index;
(xi) Inflecting translated adjectives, prepositions and article words according to nouns grammar form using respective vocabulary paradigm;
(xii) Re-arranging translated words order in each text fragment using grammar rule of target language according to grammar function of each word;

2. The method of claim 1 including vocabulary of idioms and respective transilation further comprising the steps of:
(xiii) Search each text fragments for idioms according idioms vocabulary,
(xiv) Record respective translation of idioms;

3. The method of claim 1 wherein translating words from source language to target language further include the steps of:
(xv) Locate all possible translation of each word using translation index;
(xvi) Detect all synonyms of translated word using thesaurus database;
(xvii) Selecting preferred translation word or synonym word according to Identified sentence subject, dominant tense form, meaning of detected idioms and meaning of adjacent words.

4. The method of claim 1 wherein the subject of the sentence is determined according to the word located after/before the first verb.

5. The method of claim 1 further comprising the step of locating key word which are frequently used in specific area.

6. The method of claim 6 further comprising the stop of detecting sentence context according to located key words.

7. The method of claim, 3 and 7 wherein the selection of preferred word for translation is determined additionally by detected sentence context.

8. The method of claim I further comprising the step of
(xviii) Intercepting communication data received by a terminal computer;
(xix) Detecting tem objects (“text sentences”) in communication data designated for display;
(xx) Processing the detected text sentences according the steps (i) to (xii);
(xxi) Replacing original text objects with the respective translation,

9. The method of claim 8 further comprising the step of detecting dominant language of text objects (“source language”) according language frequent key words. such as “the” in English.

10. The method of claim 9 further comprising the step of determining target language according to user definitions;

11. The method of claim 8 further comprising the step of:
(xxii) Racording original fragments text and translated text of frequently used sentences;
(xxiii) In case of detecting recorded sentences in text objects retrieve recorded translation text and to replace original text;

12. The method of claim 8 further comprising the steps of:
(xxiv) Recording translated text of groups of frequently used groups of text objects;
(xxv) In case of detecting group of recorded sentences in text objects retrieve recorded translation text and to replace original text;

13. The method of claim 9 further comprising the step of changing alignment of text objects according to paragraph format rules of target language;

14. The method of claim 8 wherein the text objects content is identified according to key words installed within the communication data.

15. A system for translating te, Fentences from source language to target language comprising databases including vocabulary and thesaurus of source and target languages, graummar function of each word, translation index vocabulary of verbs paradigm, vocabulary of preposition, adverb and adjectives inflections, said system comprising of:
(i) Editing means for breaking sentence to text fragments according to punctuation marks;
(ii) Analyzing means for Identifying grammar form of text fragments according to verb inflection, punctuation marks and grammar key words;
(iii) Analyzing means for Identifying dominant tense form of sentence according to verb inflection and identified grammar form of text fragments;
(iv) Analyzing means for Identifying subject of sentence according to word located afterlbefora the first preposition;
(v) Detecting means for locating all verbs in text fragment
(vi) Matching means for translating each verb to source grammar form in target language using translation index;
(vii) Editing means for Inflecting each translated verb using vocabulary paradigm according to dominant tense form and according to identified subject;
(viii) Detecting means for locating all nouns in text fragment
(ix) Matching means for translating each noun to source grammar form in target language using translation index;
(x) Analyzing means for identifying each noun grammar form and inflection such as single plural or malaefemale;
(xi) Detecting means for locating all adjectives, prepositions and article words relating to each noun,
(xii) Matching means for translating located adjectives, prepositions and article words using translation index aococding to respective vocabulary and translation index;
(xiii) Edit means for lnflecting translated adjectives, prepositions and article words according to nouns grammar form using respective vocabulary paradigm;
(xiv) Editing means for re-arranging translated words order in each text fragment using grammar rule of target language according to grammar function of each word;

16. The system of claim 15 further induding vocabulary of idioms and their respective translation

17. The system of claim is further comprising of:
(xv) Detecting means for locating idioms in each text fragment according idioms vocabulary;
(xvi) Recording means for storing respective translation of Idioms;

18. The system of claim 16 - wherein the process of translating words from source language to target language further comprise of:
(xvii) Detecting means for locating all possible translation of each word using translation index;
(xviii) Detecting means fof locating all synonyms of translated smrd using thesaurus database;
(xix) Analyzing means for selecting preferred translation word or synonym word according to identified sentence subject, dominant tense form, meaning of detected idioms and meaning of adjacent words.

19. The system of claim 15 wherain the subject of the sentence is determined according to the word appearing afterabofore the first verb,

20. The system of claim 15 further comprising of detecting means for locating key word which are frequently used in specific area;

21. The system of claim 20 further comprising of analyzing means for determining sentence context amcording to located key wrds.

22. The system of claim 18 wherein the selection process of the preferred merd for translation is determined additionally by determined sentence context.

23. The system of claim 1 further comprising of:
(xx) Communication means for intercepting communication data received by a terminal computer;
(xxi) Detecting means for identifying text objects (“text sentences”) in communication data designated for display;
(xxii) Programming means for processing the detected text sentences according the steps (i) to (xii);
(xxiii) Editing means for replacing original text objets with the respective translation;

24. The system of claim 21 further comprising of detecting means for identifying dominant language of text objects (“source language”) according language frequent key words, such as “the” in English.

25. The system of claim 24 further comprising the stop of determining target language according to user definitions.

26. The system of claim 23 further comprising of:
(xxiv) Recording means for storing original fragments text and translated text of frequently used sentences;
(xxv) Detecting means for identifying recorded text sentences,
(xxvi) Editing means for retrieving recorded translation text and to replace original text in case of detecting recorded sentences in text objects

27. The system of claim 23 further comprising the steps of:
(xxvii) Recording means for storing translated text of groups of frequently used groups of text object;
(xxviii) Detecting means for identifying recorded groups of text sentences;
(xxix) Editing means for retrieving recorded translation text and to replace original text, in case of detecting group of recorded sentences in text objects;

28. The system of claim 25 further comprising of editing means for changing alignment of text objects according to paragraph format rules of target language;

29. A The system of claim 20 wherein the key words are located at the communication data as mere clefined and installed by the data author.
